(19) United States
(12) Patent Application Publication
(10) Pub. No.: US 2010/0239274 A1
(43) Pub. Date: Sep. 23, 2010

(54) TONER DETERIORATION JUDGING METHOD, DEVELOPING APPARATUS AND IMAGE FORMING APPARATUS

(75) Inventors: Makoto Sato, Matsumoto (JP); Takamasa Ikagawa, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/712,626

(22) Filed: Feb. 25, 2010

(30) Foreign Application Priority Data
Mar. 23, 2009 (JP) 2009-070167

(51) Int. Cl. G03G 15/08; G03G 15/095

(52) U.S. Cl. 399/29; 399/61; 399/264

(57) ABSTRACT

A toner deterioration judging method includes measuring a time taken for a recess formed on a toner surface to be evened due to flowability of the toner, and judging deterioration of the toner in accordance with the measured time.

### BACKGROUND

1. Technical Field

The present invention relates to a toner deterioration judging method, a developing apparatus and an image forming apparatus by which an electrostatic latent image on a latent image carrier is developed with toner.

2. Related Art

If a low duty printing is continued, toner is progressively deteriorated. As a countermeasure against the problem, JP-A-2000-181216 discloses a technique in which toner is developed on a non-image area to discard the toner in accordance with the number of printed sheets or a driving time of the development.

However, in the past techniques, an actual toner state cannot be grasped accurately, since the deterioration of toner is expected with time. For example, variation in biting amounts of a developing roller and a developing agent supply roller is caused or a selectivity of toner used for development depending on patterns thereof is caused even at the same printing duty. Therefore, a progression rate of the deterioration of the toner is changed. As a result, there have been problems that a timing of discarding toner is delayed to increase an amount of fogging and usable toner is wasted.

### SUMMARY

An advantage of some aspects of the invention is to provide a toner deterioration judging method, a developing apparatus and an image forming apparatus by which a toner state is detected with high accuracy.

A toner deterioration judging method according to an aspect of the invention includes measuring a time taken for a recess formed on a toner surface to be evened due to flowability of the toner, and judging the deterioration of the toner in accordance with the measured time. Accordingly, the flowability of the toner is directly detected to judge the deterioration of the toner, thereby improving accuracy of the judgment result. This makes it possible to use the judgment result as triggers of various control indicators such as toner supply, toner discharge, toner circulation, and replacement time.

A developing apparatus according to another aspect of the invention includes a developing agent carrier that carries toner, a developing chamber that stores toner to be supplied to the developing agent carrier, a first detector that detects a toner level in the developing chamber, and a second detector that detects a toner level and is arranged so as to be deviated in the vertical direction with respect to the first detector. With this configuration, the flowability of the toner can be directly detected.

Further, it is preferable that the developing apparatus include a moving member that moves toner to be detected by the second detector. Therefore, the flowability of the toner can be detected successfully.

Further, it is preferable that the second detector detect toner levels before and after the moving member moves the toner. Therefore, the flowability of the toner can be detected more successfully.

Further, it is preferable that the moving member be a cleaning member that cleans the first detector. Therefore, toner adhered to the first detector can be reduced.

Further, it is preferable that the moving member be a cleaning member that cleans the second detector. Therefore, toner adhered to the second detector can be reduced.

Further, it is preferable that the first detector and the second detector be integrally formed. Therefore, the space can be effectively used and the cost can be lowered.

In addition, an image forming apparatus according to still another aspect of the invention includes at least a latent image carrier on which an electrostatic latent image is formed, a developing apparatus that develops the electrostatic latent image with a developing agent to form a toner image on the latent image carrier, and a transfer portion that transfers the toner image formed on the latent image carrier onto a transfer material. In the image forming apparatus, the above-mentioned developing apparatus is provided, accordingly, the flowability of the toner can be directly detected. The flowability of the toner can be used as an indicator when an image is formed so that a preferable image is formed.

It is preferable that the image forming apparatus include a judging portion that judges the deterioration of toner in accordance with the toner level detected by the first detector and the toner absence time detected by the second detector. Therefore, the flowability of the toner can be directly detected to judge the deterioration of the toner, thereby improving accuracy of the judgment result. This makes it possible to use the judgment result as triggers of various control indicators such as toner supply, toner discharge, toner circulation, and a replacement time.

### BRIEF DESCRIPTION OF THE DRAWINGS

The invention will be described with reference to the accompanying drawings, wherein like numbers reference like elements.

FIG. 1 is a view illustrating an image forming apparatus according to an embodiment of the invention.

FIG. 2 is a cross-sectional view illustrating main components in the vicinity of a photosensitive member and those of a developing cartridge.

FIG. 3 is a schematic view of the developing cartridge seen from the axial direction thereof.

FIG. 4 is a view seen from the arrow IV of FIG. 3.

FIG. 5 is a graph showing flowability of toner with respect to the number of times the toner passes through a nip.

FIG. 6 is a flowchart of a toner deterioration judging method.

FIGS. 7A to 7C are views illustrating operation states of a toner sensor cleaning portion 155Y.

FIGS. 8A and 8B are views illustrating a first toner level.

FIG. 9A is a view illustrating toner levels.

FIGS. 9B and 9C are views illustrating sensor output signals.

FIGS. 10A and 10B are views illustrating a second toner level.

FIG. 11A is a view illustrating toner levels.

FIGS. 11B and 11C are views illustrating sensor output signals.

FIGS. 12A and 12B are views illustrating a third toner level.

FIG. 13A is a view illustrating toner levels.

FIGS. 13B and 13C are views illustrating sensor output signals.

FIG. 14 is a view illustrating another embodiment of the invention.

### DESCRIPTION OF EXEMPLARY EMBODIMENTS

Hereinafter, an embodiment according to an aspect of the invention will be described with reference to drawings.

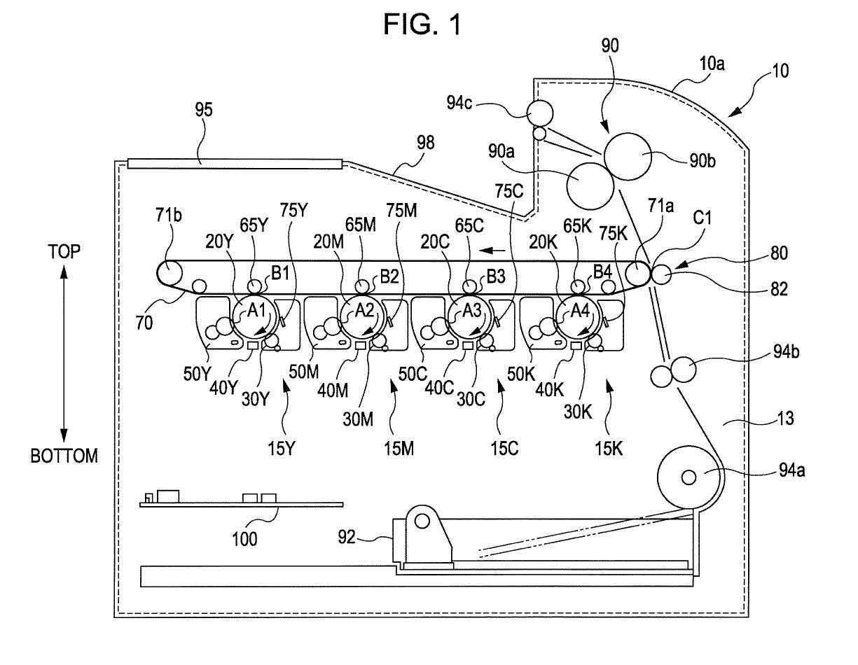

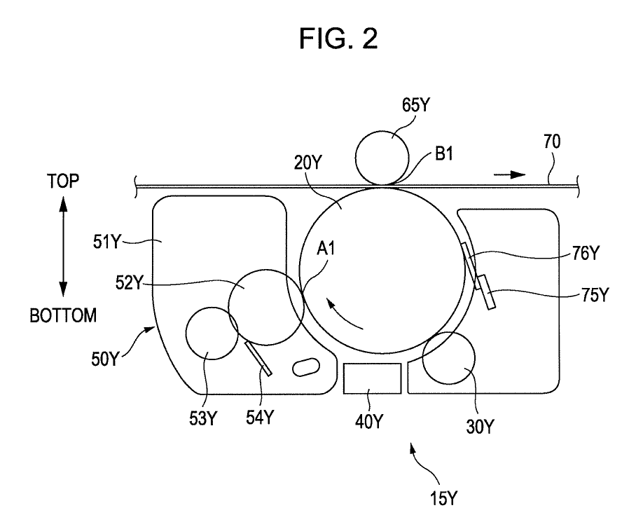

FIG. 1 is a view illustrating an embodiment of an image forming apparatus including a developing apparatus according to the invention. FIG. 2 is an enlarged view of a yellow image forming station of FIG. 1.

As shown in FIG. 1, an image forming apparatus 10 includes four image forming stations 15 (Y, M, C, K), an intermediate transfer belt 70, a secondary transfer unit 80; further including a fixing unit 90, a display unit 95 which is an information unit and formed of a liquid crystal panel, and a control unit 100 which controls these units to carry out operation as an image forming apparatus.

Each of the image forming stations 15 (Y, M, C, K) has a function of forming an image with toner of each of yellow (Y), magenta (M), cyan (C) and black (K). Since the image forming stations 15 (Y, M, C, K) have the same configuration, the image forming station 15Y is described below.

As shown in FIG. 2, the image forming station 15Y has a charging unit 30Y, an exposing unit 40Y, a developing cartridge 50Y as a developing apparatus, a primary transfer portion B1 and a photosensitive member cleaning unit 75Y along the rotational direction of a photosensitive member 20Y as an example of a latent image carrier.

The photosensitive member 20Y has a cylindrical base material and a photosensitive layer formed on an outer circumferential surface of the base member. Further, the photosensitive member 20Y is rotatable about a center axis and rotates in the clockwise direction as shown by an arrow in the embodiment.

The charging unit 30Y is an apparatus for charging the photosensitive member 20Y. A latent image is formed on the photosensitive member 20Y charged by laser irradiation from the exposing unit 40Y.

The exposing unit 40Y has a semiconductor laser, a polygon mirror, an F-θ lens, and the like. The exposing unit 40Y irradiates the charged photosensitive member 20Y with a modulated laser based on an image signal input from a host computer (not shown) such as a personal computer and a word processer.

The developing cartridge 50Y is an apparatus for developing the latent image formed on the photosensitive member 20Y with yellow (Y) toner. In the developing cartridge 50Y, a developing roller 52Y as a developing agent carrier and a toner supply roller 53Y as a toner supply member are arranged in a developing chamber 51Y to which new toner is supplied from an exchangeable toner cartridge (not shown). Further, a regulation blade 54Y as a regulation member abuts against the developing roller 52Y to form toner on the developing roller 52Y to be a thin layer.

The regulation blade 54Y is arranged above or below the developing roller 52Y and regulates an amount of toner carried on the developing roller 52Y. When the regulation blade 54Y is arranged below the developing roller 52Y, toner passing through a nip portion between the developing roller 52Y and the toner supply roller 53Y drops to a bottom part in the developing cartridge 50Y more easily. In this case, the regulation blade 54Y is arranged such that the regulation blade 54Y abuts against the developing roller 52Y in the counter direction with respect to the rotational direction of the developing roller 52Y.

The primary transfer portion B1 transfers a yellow toner image formed on the photosensitive member 20Y onto the intermediate transfer belt 70. When four colors of toner are sequentially transferred at each of the primary transfer portions B1, B2, B3, B4 in a superimposed manner, a full color toner image is formed on the intermediate transfer belt 70.

The intermediate transfer belt 70 is an endless belt laid between a belt driving roller 71a and a driven roller 71b in a tension state. The intermediate transfer belt 70 is rotationally driven while abutting against the photosensitive members 20 (Y, M, C, K).

The secondary transfer unit 80 is an apparatus for transferring a single color toner image or a full color toner image formed on the intermediate transfer belt 70 onto a transfer material such as a paper, a film and a fabric.

The fixing unit 90 includes a fixing roller 90a and a pressure roller 90b. Further, the fixing unit 90 is an apparatus for fusing, onto the transfer material, the single color toner image or the full color toner image transferred onto the transfer material so as to form a permanent image.

The photosensitive member cleaning unit 75Y has a photosensitive member cleaning blade 76Y made of rubber. The photosensitive member cleaning blade 76Y abuts against a surface of the photosensitive member 20Y. The photosensitive member cleaning unit 75Y is an apparatus for scratching off toner remaining on the photosensitive member 20Y by the photosensitive member cleaning blade 76Y so as to remove the toner after the toner image is transferred onto the intermediate transfer belt 70 at the primary transfer portion B1.

Next, an operation of the image forming apparatus 10 configured as described above will be described.

At first, when an image signal and a control signal from a host computer (not shown) is input to a main controller of the image forming apparatus through an interface, the photosensitive member 20Y, the developing roller 52Y included in the developing cartridge 50Y, the supply roller 53Y, the intermediate transfer belt 70 and the like rotate. These components are controlled to rotate by a unit controller based on an instruction from the main controller. The photosensitive member 20Y is sequentially charged by the charging unit 30Y at a charge position while rotating.

The charged area of the photosensitive member 20Y moves to an exposure position with the rotation of the photosensitive member 20Y. Then, a latent image in accordance with image information of the yellow Y is formed on the charged area by the exposing unit 40Y.

The latent image formed on the photosensitive member 20Y moves to a development position with the rotation of the photosensitive member 20Y so as to be developed by the developing cartridge 50Y. Thus, a toner image is formed on the photosensitive member 20Y.

The toner image formed on the photosensitive member 20Y moves to a position of the primary transfer portion B1 with the rotation of the photosensitive member 20Y so as to be transferred onto the intermediate transfer belt 70 by a primary transfer unit. In this case, a primary transfer voltage having a polarity opposite to a charge polarity of the toner is applied to the primary transfer unit. As a result, toner images of four colors formed on each of the photosensitive members 20 (Y, M, C, K) are transferred onto the intermediate transfer belt 70 in a superimposed manner so that a full color toner image is formed on the intermediate transfer belt 70.

The intermediate transfer belt 70 is driven by a driving force from a belt driving unit such as a motor. The driving force is transmitted to the intermediate transfer belt 70 through the belt driving roller 71a.

The full color toner image formed on the intermediate transfer belt 70 is transferred onto a transfer material such as a paper by the secondary transfer unit 80. Such transfer material is transported to the secondary transfer unit 80 through a feeding roller 94a and a registration roller 94b from a paper feed tray.

A full color liquid developing agent image transferred onto the transfer material is fused to the transfer material by heat and pressure applied by the fixing unit 90. After passing through the fixing unit 90, the transfer material is discharged from a paper discharge roller 94c.

On the other hand, after the photosensitive members 20 (Y, M, C, K) pass through positions of the primary transfer portions B1, B2, B3, B4, respectively, the photosensitive members 20 are destaticized by destaticizing units (not shown). Further, toner adhered to each photosensitive member 20 is scratched off by the surface of each of the photosensitive member cleaning blades 76 (Y, M, C, K) so that the photosensitive members 20 prepare for being charged for forming the next latent image. The photosensitive member cleaning blades 76 (Y, M, C, K) are supported by the photosensitive member cleaning units 75 (Y, M, C, K), respectively. The toner scratched off is collected by a remaining-toner collecting portion included in each of the photosensitive member cleaning units 75 (Y, M, C, K).

An intermediate transfer belt cleaning apparatus (not shown) is arranged on the driven roller 71b side of the intermediate transfer belt 70 to clean the intermediate transfer belt 70 after the secondary transfer. It is to be noted that although the embodiment in which an intermediate transfer system using an intermediate transfer belt is employed is described, a direct transfer system may be employed in the image forming apparatus.

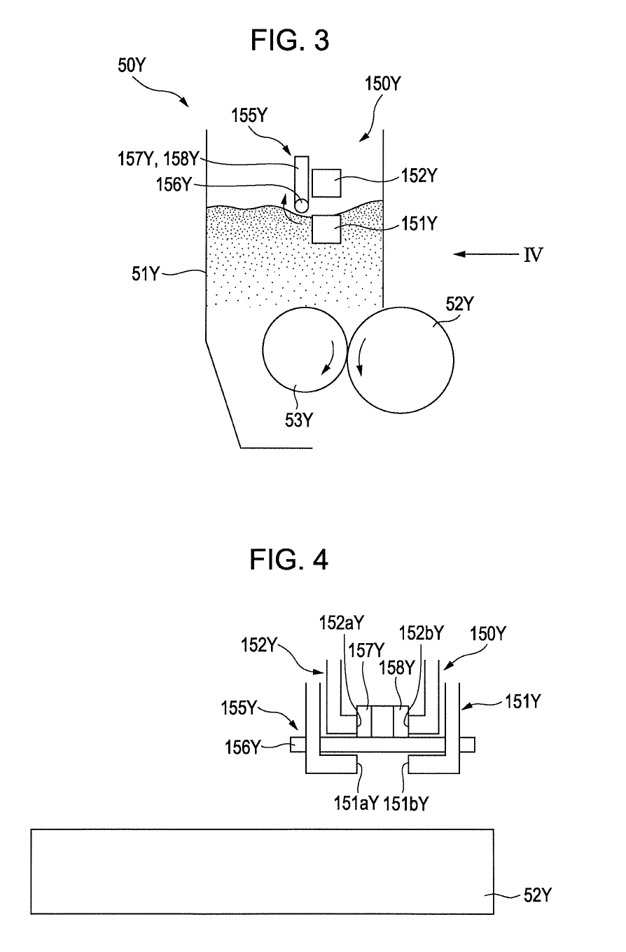

Next, a toner sensor 150Y in the developing chamber 51Y of the developing cartridge 50Y according to the embodiment is described. FIG. 3 is a schematic view of the developing cartridge 50Y seen from the axial direction thereof. FIG. 4 is a view seen from an arrow IV in FIG. 3.

The toner sensor 150Y is arranged above the developing roller 52Y and the toner supply roller 53Y in the developing chamber 51Y of the developing cartridge 50Y. The toner sensor 150Y has a toner level sensor 151Y serving as a first detector and a toner state sensor 152Y serving as a second detector. The toner state sensor 152Y is arranged above the toner level sensor 151Y in the vertical direction.

The toner level sensor 151Y has a first light projecting portion 151aY which projects a light and a first light receiving portion 151bY which receives the light projected by the first light projecting portion 151aY. The first light projecting portion 151aY and the first light receiving portion 151bY are arranged facing each other in the axial direction of the developing roller 52Y and the toner supply roller 53Y.

The toner level sensor 151Y detects the presence of toner to output an ON signal when the light projected by the first light projecting portion 151aY is not received by the first light receiving portion 151bY. On the other hand, the toner level sensor 151Y detects the absence of toner to output an OFF signal when the light projected by the first light projecting portion 151aY is received by the first light receiving portion 151bY.

The toner state sensor 152Y has a second light projecting portion 152aY which projects a light and a second light receiving portion 152bY which receives the light projected by the second light projecting portion 152aY. The second light projecting portion 152aY and the second light receiving portion 152bY are arranged facing each other in the axial direction of the developing roller 52Y and the toner supply roller 53Y.

The toner state sensor 152Y detects the presence of toner to output an ON signal when the light projected by the second light projecting portion 152aY is not received by the second light receiving portion 152bY. On the other hand, the toner state sensor 152Y detects the absence of toner to output an OFF signal when the light projected by the second light projecting portion 152aY is received by the second light receiving portion 152bY.

A toner sensor cleaning portion 155Y is provided adjacent to the toner sensor 150Y in the developing chamber 51Y. The toner sensor cleaning portion 155Y has a rotational axis 156Y, a light projecting portion cleaning member 157Y as a moving member and a light receiving portion cleaning member 158Y as a moving member. The rotational axis 156Y extends in parallel with the axial direction of the developing roller 52Y and the toner supply roller 53Y. The light projecting portion cleaning member 157Y and the light receiving portion cleaning member 158Y are attached to the rotational axis 156Y and rotate along with the rotational axis 156Y. The light projecting portion cleaning member 157Y and the light receiving portion cleaning member 158Y are integrally formed.

The light projecting portion cleaning member 157Y is made of such as an elastic member, a urethane foam material, a thin sheet or the like. The light projecting portion cleaning member 157Y is in slidable contact with the first light projecting portion 151aY and the second light projecting portion 152aY, and scratches off toner to clean the light projecting portions. The light receiving portion cleaning member 158Y is also made of such as an elastic member, a urethane foaming material, a thin sheet or the like. The light receiving portion cleaning member 158Y is in slidable contact with the first light receiving portion 151bY and the second light receiving portion 152bY, and scratches off toner to clean the light receiving portions.

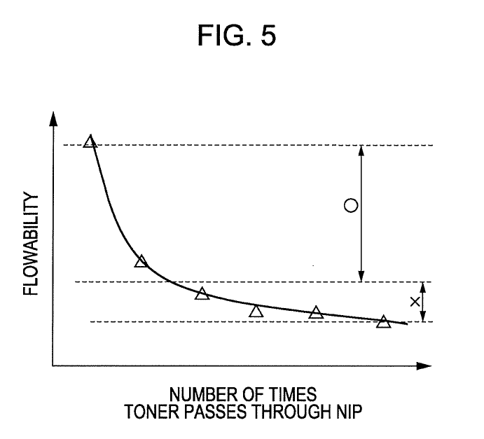

Then, the deterioration of toner will be described. FIG. 5 is a graph showing flowability of toner with respect to the number of times the toner passes through a nip. As shown in FIG. 5, when toner passes through a nip portion between the developing roller 52Y and the toner supply roller 53Y in the developing chamber 51Y, the toner receives a stress because pressure or bias is applied. As the number of times the toner passes through the nip portion increases, an external additive is released or embedded so that the toner becomes deteriorated. Further, the flowability of the toner is lowered in relation to progression of the deterioration of the toner. In the embodiment, the deterioration state of toner is judged by detecting the flowability of the toner.

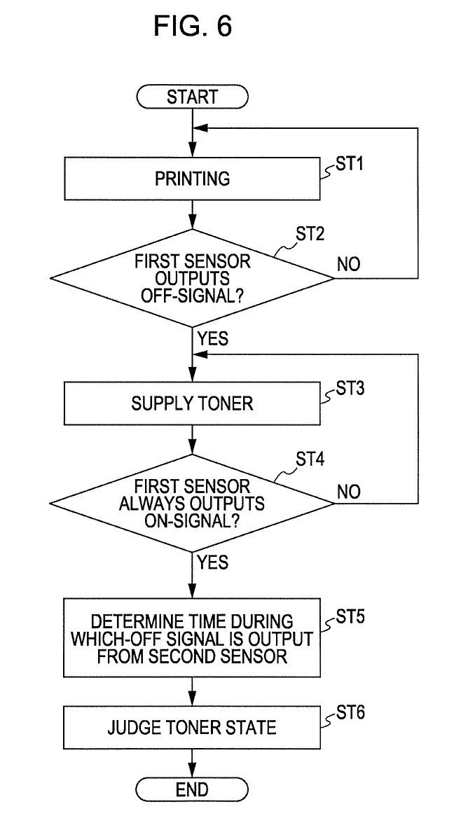

A toner deterioration judging method according to the embodiment is described. FIG. 6 is a flowchart of the toner deterioration judging method. It is to be noted that the toner sensor cleaning portion 155Y is assumed to be always in the operated state.

At first, toner is consumed by printing at ST1. It is judged whether the toner level sensor 151Y outputs an OFF signal at ST2.

At ST2, if the toner level sensor 151Y outputs an ON signal and a toner level at a toner surface position is still higher than the toner level sensor 151Y, the process returns to ST1 and the toner is consumed by printing.

At ST2, if the toner level sensor 151Y outputs the OFF signal and the toner level is lower than the toner level sensor 151Y, toner is supplied at ST3.

Next, it is judged whether the toner level sensor 151Y always outputs the ON signal at ST4. At ST4, if the toner level sensor 151Y outputs the OFF signal, the process returns to step 3 and toner is supplied.

If the toner level sensor 151Y always outputs the ON signal at ST2, a time during which the OFF signal is output from the toner state sensor 152Y is measured at ST5.

Subsequently, the toner state is judged by a judging portion (not shown) in accordance with the time during which the OFF signal is output from the toner state sensor 152Y at ST6.

Next, judgment of a toner state is described in detail.

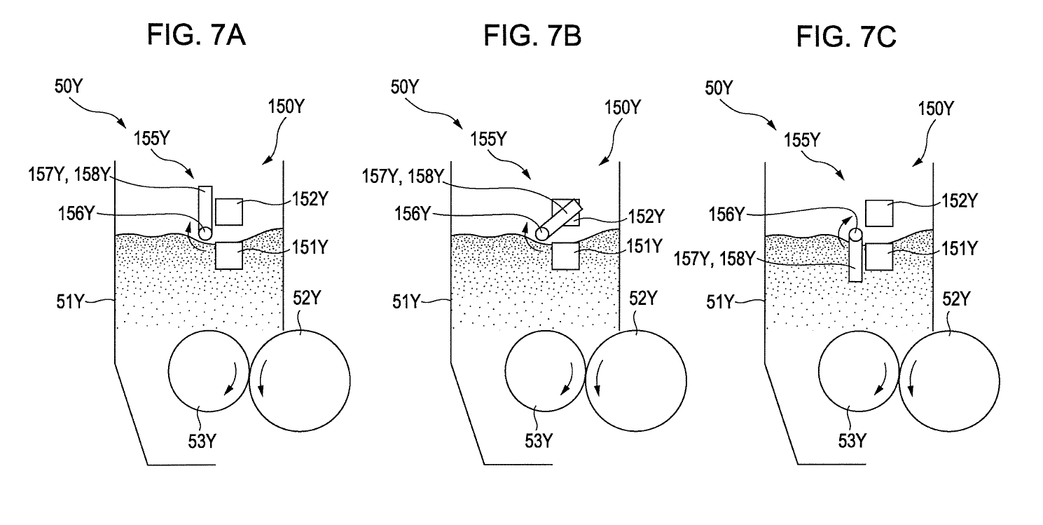

FIGS. 7A to 7C are views illustrating operation states of the toner sensor cleaning portion 155Y. Specifically, FIG. 7A is a view illustrating a state of the toner sensor cleaning portion 155Y before cleaning, FIG. 7B is a view illustrating a state of the toner sensor cleaning portion 155Y during cleaning and FIG. 7C is a view illustrating a state of the toner sensor cleaning portion 155Y after cleaning.

In the judgment of the deterioration of the toner according to the embodiment, replenishment of toner is continued until the toner level sensor 151Y becomes to always output the ON signal, then a toner state is judged in accordance with the time during which the OFF signal is output from the toner state sensor 152Y after the cleaning of the toner state sensor 152Y.

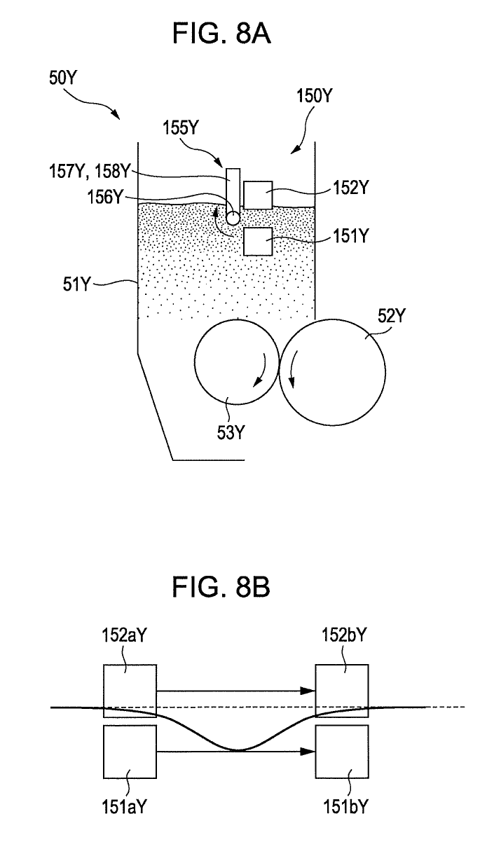

At first, a case where NEW toner is detected is described. FIGS. 8A and 8B are views illustrating a first toner level at which the NEW toner is detected. FIG. 8A is a view illustrating the first toner level when the toner level sensor 151Y always outputs the ON signal. FIG. 8B is an enlarged view in the vicinity of the toner sensor 150Y immediately after being cleaned. Further, a dotted line in FIG. 8B indicates the first toner level before the cleaning by the toner sensor cleaning portion 155Y shown in FIG. 7A and a solid line in FIG. 8B indicates a toner level after the cleaning by the toner sensor cleaning portion 155Y shown in FIG. 7C.

A recess is formed between the light projecting portions 151aY, 152aY and the light receiving portions 151bY, 152bY when the light projecting cleaning member 157Y and the light receiving portion cleaning member 158Y carry out the cleaning operation to scratch off the toner. The recess is at a position indicated by the solid line in FIG. 8B. Subsequently, the toner level at the recess returns to an original toner level due to the flowability of the toner.

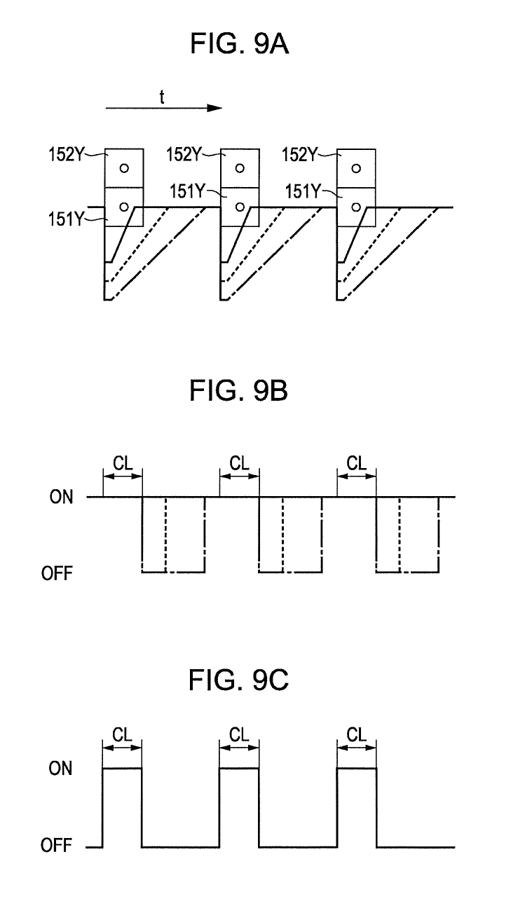

FIGS. 9A to 9C are views illustrating toner levels and sensor output signals. FIG. 9A is a view illustrating toner levels. FIG. 9B is a view illustrating sensor output signals output from the toner level sensor 151Y. FIG. 9C is a view illustrating sensor output signals output from the toner state sensor 152Y. In FIGS. 9A to 9C, solid lines correspond to NEW toner, dotted lines correspond to toner with a small degree of deterioration, and dashed-dotted lines correspond to toner with a large degree of deterioration. Further, the direction of an arrow indicates the passage of time in all of FIGS. 9A to 9C.

FIG. 9A illustrates toner levels with respect to the time passage. As shown in FIG. 9A, the toner level of the NEW toner immediately returns to an original toner level after the cleaning. However, the toner level of the toner with a small degree of deterioration returns later than that of the NEW toner, and the toner level of the toner with a large degree of deterioration returns far more later.

The output signals from the toner level sensor 151Y in FIG. 9B show that the toner level of the NEW toner indicated by solid lines returns to an original toner level before the cleaning members 157Y and 158Y completely pass between the first light projecting portion 151aY and the first light receiving portion 151bY as shown in FIG. 7C. That is, the output signal from the toner level sensor 151Y is always in the ON state.

However, the toner level detected by the toner level sensor 151Y is affected by the deterioration of the toner. Accordingly, an actual toner level or the deterioration of the toner cannot be judged at this time. For example, when the toner is deteriorated, the output signal from the toner level sensor 151Y is not always in the ON state unless the toner level becomes higher than that in the case of the NEW toner since the flowability of the toner is low and the toner level returns later.

In the embodiment, the deterioration of toner is judged from a sensor output signal from the toner state sensor 152Y at the time when the output signal from the toner level sensor 151Y is always in the ON state by replenishing toner.

At the time when the output signal from the toner level sensor 151Y is always in the ON state, the sensor output signal from the toner state sensor 152Y as shown in FIG. 9C is in the ON state only when the cleaning members 157Y and 158Y pass between the first light projecting portion 151aY and the first light receiving portion 151bY. This shows that the toner level is lower than the toner state sensor 152Y. Therefore, it is recognized that the flowability of the toner is excellent and the recess is filled with toner immediately after the cleaning members 157Y and 158Y scratch off the toner.

Accordingly, at the time when the output signal from the toner level sensor 151Y is always in the ON state, if the output signal from the toner state sensor 152Y is in the ON state only when the cleaning members 157Y and 158Y pass between the first light projecting portion 151aY and the first light receiving portion 151bY, it is possible to judge that the toner is NEW toner having good flowability.

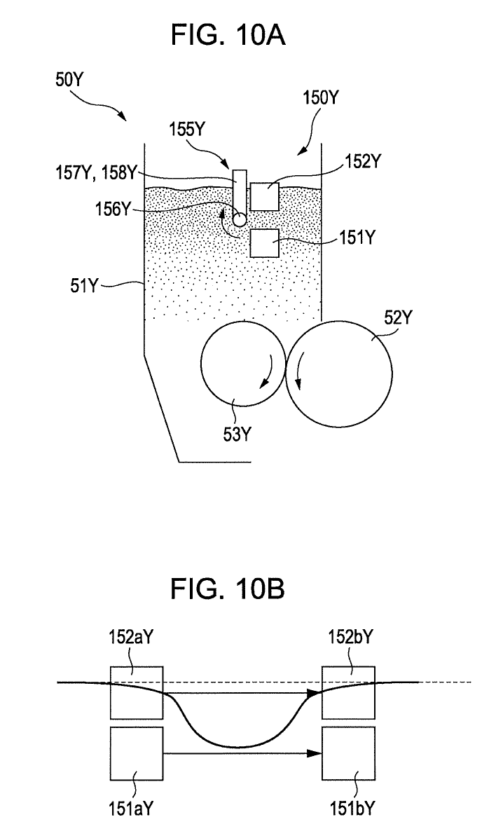

Next, a case where toner with a small degree of deterioration is detected will be described. FIGS. 10A and 10B are views illustrating a second toner level. FIG. 10A is a view illustrating the second toner level at the time when the toner level sensor 151Y always outputs the ON signal. FIG. 10B is an enlarged view in the vicinity of the toner sensor 150Y immediately after the cleaning. Further, a dotted line in FIG. 10B indicates the second toner level before the cleaning by the toner sensor cleaning portion 155Y shown in FIG. 7A, and a solid line in FIG. 10B indicates a toner level after the cleaning by the toner sensor cleaning portion 155Y shown in FIG. 7C.

A recess is formed between the light projecting portions 151aY, 152aY and the light receiving portions 151bY, 152bY when the light projecting cleaning member 157Y and the light receiving portion cleaning member 158Y carry out the cleaning operation to scratch off the toner. The recess is at a position indicated by the solid line in FIG. 10B. Subsequently, the toner level at the recess returns to an original toner level due to the flowability of the toner.

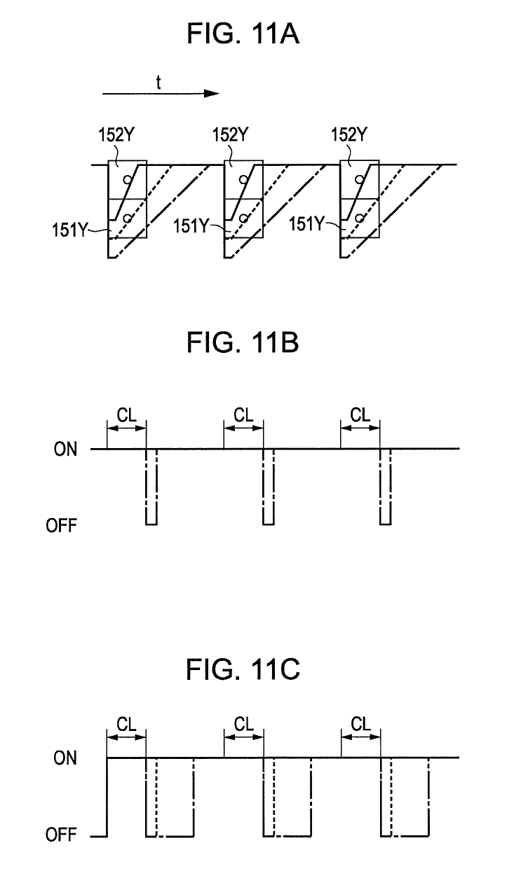

FIGS. 11A to 11C are views illustrating toner levels and sensor output signals. FIG. 11A is a view illustrating toner levels. FIG. 11B is a view illustrating sensor output signals output from the toner level sensor 151Y. FIG. 11C is a view illustrating sensor output signals output from the toner state sensor 152Y. In FIGS. 11A to 11C, solid lines correspond to NEW toner, dotted lines correspond to toner with a small degree of deterioration, and dashed-dotted lines correspond to toner with a large degree of deterioration. Further, the direction of an arrow indicates the passage of time in all of FIGS. 11A to 11C.

FIG. 11A illustrates toner levels with respect to the time passage. As shown in FIG. 11A, the toner level of the NEW toner immediately returns to an original toner level after the cleaning. However, the toner level of the toner with a small degree of deterioration returns later than that of the NEW toner, and the toner level of the toner with a large degree of deterioration returns far more later.

The output signals from the toner level sensor 151Y in FIG. 11B show that the toner level of the NEW toner indicated by solid lines and the toner level of the toner with a small degree of deterioration indicated by dotted lines return to an original toner level before the cleaning members 157Y and 158Y completely pass between the first light projecting portion 151aY and the first light receiving portion 151bY as shown in FIG. 7C. That is, the output signal from the toner level sensor 151Y is always in the ON state.

However, the toner level detected by the toner level sensor 151Y is affected by the deterioration of the toner. Accordingly, an actual toner level or the deterioration state of toner cannot be judged at this time. For example, in the case of the NEW toner, the output signal from the toner level sensor 151Y is always in the ON state at the first toner level immediately above the position of the toner level sensor 151Y. In the case of the toner with a large degree of deterioration, the output signal from the toner level sensor 151Y is not always in the ON state unless the toner level becomes higher than that in the case of the toner with a small degree of deterioration since the flowability of the toner is low and the toner level returns later.

In the embodiment, the deterioration of toner is judged from a sensor output signal from the toner state sensor 152Y at the time when the output signal from the toner level sensor 151Y is always in the ON state by replenishing toner.

In the case of the NEW toner, the output signal from the toner level sensor 151Y is always in the ON state at the first toner level. Further, as shown in FIG. 9C, the sensor output signal from the toner state sensor 152Y should be in the ON state only when the cleaning members 157Y and 158Y pass between the first light projecting portion 151aY and the first light receiving portion 151bY. Therefore, it is judged that the toner is not NEW toner. Just for reference, in the case of the NEW toner, the output signal from the toner state sensor 152Y as shown in FIG. 11C is always in the ON state at the second toner level although the toner level does not reach the second toner level in the case of the NEW toner.

In the case of the toner with a small degree of deterioration, after the cleaning members 157Y and 158Y pass between the first light projecting portion 151aY and the first light receiving portion 151bY, the sensor output signal from the toner state sensor 152Y is once in the OFF state for a short period of time, and then becomes in the ON state.

Further, in the case of toner with a large degree of deterioration, as shown in FIG. 11B, since the output signal from the toner level sensor 152Y is not always in the ON state at the second toner level, the output signal from the toner state sensor 152Y should not be detected. Just for reference, at the second toner level, after the cleaning members 157Y and 158Y pass between the first light projecting portion 151aY and the first light receiving portion 151bY, the sensor output signal from the toner state sensor 152Y is once in the OFF state for a period of time which is longer than that in the case of the toner with a small degree of deterioration, then becomes in the ON state.

Accordingly, it is possible to judge that the toner is the one with a small degree of deterioration when the output signal from the toner state sensor 152Y at the time when the output signal from the toner level sensor 151Y is always in the ON state is once in the OFF state for a short period of time, then becomes in the ON state.

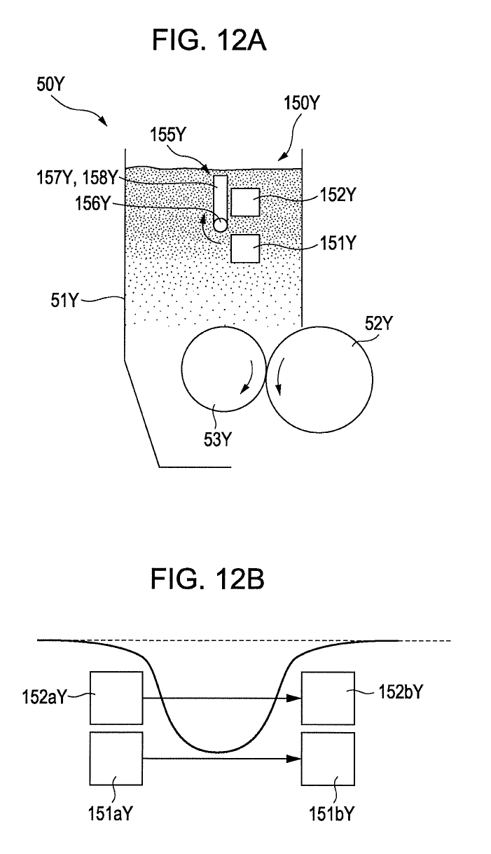

FIGS. 12A and 12B are views illustrating a third toner level. FIG. 12A is a view illustrating the third toner level in a state where the toner level sensor 151Y always outputs the ON signal. FIG. 12B is an enlarged view in the vicinity of the toner sensor 150Y immediately after the cleaning. Further, a dotted line in FIG. 12B indicates the third toner level before the cleaning by the toner sensor cleaning portion 155Y shown in FIG. 7A, and a solid line in FIG. 12B indicates a toner level after the cleaning by the toner sensor cleaning portion 155Y shown in FIG. 7C.

A recess is formed between the light projecting portions 151aY, 152aY and the light receiving portions 151bY, 152bY when the light projecting cleaning member 157Y and the light receiving portion cleaning member 158Y carry out the cleaning operation to scratch off the toner. The recess is at a position indicated by the solid line in FIG. 12B. Subsequently, the toner level at the recess returns to an original toner level due to the flowability of the toner. What the toner level reaches the third toner level means that the recess is caused to be deeper.

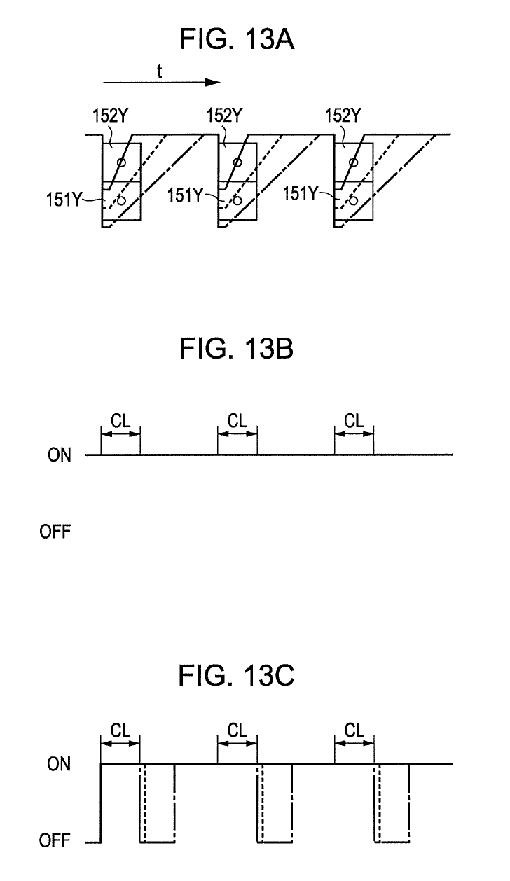

FIGS. 13A to 13C are views illustrating toner levels and sensor output signals. FIG. 13A is a view illustrating toner levels. FIG. 13B is a view illustrating sensor output signals output from the toner level sensor 151Y. FIG. 13C is a view illustrating sensor output signals output from the toner state sensor 152Y. In FIGS. 13A to 13C, solid lines correspond to NEW toner, dotted lines correspond to toner with a small degree of deterioration, and dashed-dotted lines correspond to toner with a large degree of deterioration. Further, the direction of an arrow indicates the passage of time in all of FIGS. 13A to 13C.

FIG. 13A illustrates toner levels with respect to the time passage. As shown in FIG. 13A, the toner level of the NEW toner immediately returns to an original toner level after the cleaning. However, the toner level of the toner with a small degree of deterioration returns later than that of the NEW toner, and the toner level of the toner with a large degree of deterioration returns far more later.

The output signals from the toner level sensor 151Y as shown in FIG. 13B show that all the toner return to an original toner level before the cleaning members 157Y and 158Y completely pass between the first light projecting portion 151aY and the first light receiving portion 151bY as shown in FIG. 7C. That is, the output signal from the toner level sensor 151Y is always in the ON state.

However, the toner level detected by the toner level sensor 151Y is affected by the deterioration of the toner. Accordingly, an actual toner level or the deterioration state of toner cannot be judged at this time. For example, in the case of the NEW toner, the output signal from the toner level sensor 151Y is always in the ON state at the first toner level immediately above the position of the toner level sensor 151Y. In the case of the toner with a small degree of deterioration, the output signal from the toner level sensor 151Y is always in the ON state at the second toner level higher than the first toner level in the case of the NEW toner since the flowability of the toner is low and the toner level returns later.

In the embodiment, the deterioration of toner is judged from a sensor output signal from the toner state sensor 152Y at the time when the output signal from the toner level sensor 151Y is always in the ON state by replenishing toner.

In the case of the NEW toner, the output signal from the toner level sensor 151Y is always in the ON state at the first toner level. Further, as shown in FIG. 9C, the sensor output signal from the toner state sensor 152Y should be in the ON state only when the cleaning members 157Y and 158Y pass between the first light projecting portion 151aY and the first light receiving portion 151bY. Therefore, it is recognized that the toner is not NEW toner. Just for reference, in the case of the NEW toner, the output signal from the toner state sensor 152Y as shown in FIG. 13C is always in the ON state at the second toner level although the toner level does not reach the second toner level in the case of the NEW toner.

In the case of the toner with a small degree of deterioration, the output signal from the toner level sensor 151Y is always in the ON state at the second toner level. Further, as shown in FIG. 11C, after the cleaning members 157Y and 158Y pass between the first light projecting portion 151aY and the first light receiving portion 151bY, the output signal from the toner state sensor 152Y is once in the OFF state for a short period of time, and then becomes in the ON state. Accordingly, it is recognized that the toner state can be judged by the period of time until the output signal from the toner state sensor 152Y becomes in the ON state. Just for reference, in the case of the toner with a small degree of deterioration, at the third toner level, the output signal from the toner state sensor 152Y as shown in FIG. 13C is once in the OFF state, then in the ON state immediately although the toner level does not reach the third toner level in the case of the toner with a small degree of deterioration.

Accordingly, it is possible to judge the degree of the deterioration of toner from the time until the output signal from the toner state sensor 152Y becomes in the ON state at the time when the output signal from the toner level sensor 151Y is always in the ON state.

It is to be noted that the toner level sensor 151Y and the toner state sensor 152Y is not limited to be arranged in the vertical direction, and may be arranged obliquely. Further, the arrangement space between the toner level sensor 151Y and the toner state sensor 152Y may take any length as long as the toner level sensor 151Y and the toner state sensor 152Y are located within a movable range of the cleaning members 157Y and 158Y. Moreover, the space between the first light projecting portion 151aY and the first light receiving portion 151bY and the space between the second light projecting portion 152aY and the second light receiving portion 152bY can be preferably narrower as long as the toner can flow with no obstruction into each space due to the flowability of the toner; it is preferable that the spaces be narrower because a changing time of the sensor output signal from the toner state sensor 152Y becomes relatively shorter, which makes the time taken to judge the deterioration of toner be shorter.

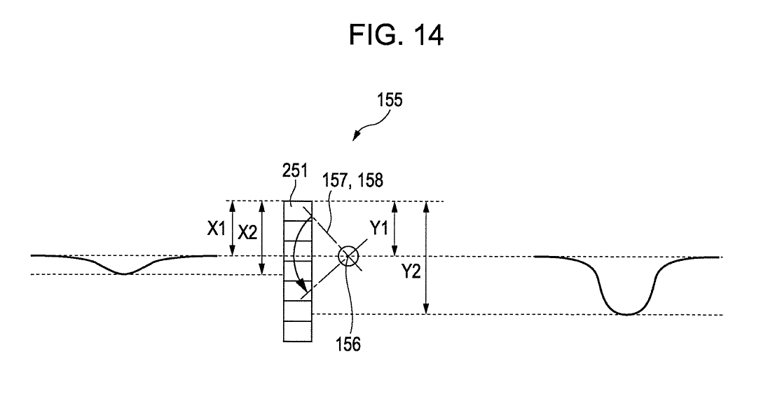

Another embodiment is described below. FIG. 14 is a view illustrating another embodiment. In the embodiment, a level sensor 251 in which a fist detector and a second detector are integrally formed is employed instead of the toner level sensor 151Y and the toner state sensor 152Y. Toner levels after and before the cleaning members 157Y and 158Y pass through the level sensor 251 are detected with the level sensor 251 so as to judge the degree of the deterioration of toner from a difference between the levels. For example, when the difference between the levels is small (in the case of X2-X1 in FIG. 14), the toner is judged to be NEW toner since the recess is filled with toner due to the flowability of the toner immediately after cleaned. On the other hand, when the difference between the levels is large (in the case of Y2-Y1 in FIG. 14), the toner is judged to be deteriorated one since the recess is not filled with toner immediately after the cleaning due to the deteriorated flowability of the toner and the recess remains longer. By using the level sensor 251, the space can be effectively used and the cost can be lowered.

In the embodiment, two sensors of the toner level sensor 151Y and the toner state sensor 152Y are cleaned with the cleaning members 157Y and 158Y integrally formed. The cleaning members 157Y and 158Y may be separately provided. However, if the cleaning members 157Y and 158Y are integrally formed, problems such as a synchronization shift and a condition change of the portions to be cleaned with the passage of time can be reduced and the cost can be lowered in comparison with the case where the cleaning members 157Y and 158Y are separately provided.

Further, judgment of the deterioration of toner and control of a toner level in the developing chamber are preferably performed during developing operation. This is because the toner in the vicinity of the sensor is sufficiently stirred and the toner level is stable during the developing operation. The cleaning members 157Y and 158Y rotationally clean two sensors of the toner level sensor 151Y and the toner state sensor 152Y from the upper portion to the lower portion. Therefore, the toner level is not elevated by the cleaning members 157Y and 158Y between the toner level sensor 151Y and the toner state sensor 152Y, thereby detecting the stabled toner level. In addition, a speed at which the cleaning members 157Y and 158Y perform cleaning operation once is faster than a speed at which the recess is filled with toner due to the flowability of the toner. Therefore, the recess can be formed after the cleaning.

According to each embodiment of the invention, a recess is formed on a part of a toner surface and a time taken to fill the recess with toner at a flowing rate of the toner corresponding to the flowability of the toner in relation to the deterioration of the toner is measured. The deterioration of the toner is judged in accordance with the measured time so that accuracy of judging the deterioration of the toner is improved.

A toner deterioration judging method according to the embodiment includes measuring a time taken to fill a recess formed on a part of a toner surface with toner due to the flowability of the toner, and judging the deterioration of the toner in accordance with the measured time (ST6). With this configuration, the flowability of the toner is directly detected to judge the deterioration of the toner, thereby improving accuracy of the judgment result. This makes it possible to use the judgment result as triggers of various control indicators such as toner supply, toner discharge, toner circulation, and a replacement time.

The developing cartridge 50Y according to the embodiment includes the developing roller 52Y that carries toner, the developing chamber 51Y that stores toner supplied to the developing roller 52Y, the toner level sensor 151Y that detects a toner level in the developing chamber 51Y, and the toner state sensor 152Y that detects a toner level and is arranged so as to be deviated in the vertical direction with respect to the toner level sensor 151Y. With this configuration, the flowability of the toner can be directly detected.

The developing cartridge 50Y includes the cleaning members 157Y and 158Y by which toner detected by the toner state sensor 152Y is moved. Therefore, the flowability of the toner can be detected successfully.

Further, the toner state sensor 152Y detects toner levels before and after the cleaning members 157Y and 158Y move the toner. Therefore, the flowability of the toner can be detected more successfully.

Further, since the cleaning members 157Y and 158Y clean the toner level sensor 151Y, toner adhered to the toner level sensor 151Y can be reduced.

In addition, since the cleaning members 157Y and 158Y clean the toner state sensor 152Y, toner adhered to the toner state sensor 152Y can be reduced.

Further, since the toner level sensor 151Y and the toner state sensor 152Y are integrally formed, the space can be effectively used and the cost can be lowered.

The image forming apparatus according to the embodiment at least includes a latent image carrier on which an electrostatic latent image is formed, a developing apparatus that develops the electrostatic latent image with a developing agent to form a toner image on the latent image carrier, and a transfer portion that transfers the toner image formed on the latent image carrier onto a transfer material. In the image forming apparatus, the above-described developing apparatus is provided as the developing apparatus. With this configuration, the flowability of the toner can be directly detected. Therefore, the flowability of the toner can be used as an indicator when an image is formed so that a preferable image is formed.

The image forming apparatus includes a judging portion that judges the deterioration of toner in accordance with the toner level detected by the toner level sensor 151Y and the toner absence time detected by the toner state sensor 152Y. Therefore, the flowability of the toner can be directly detected to judge the deterioration of the toner, thereby improving accuracy of judgment result. This makes it possible to use the judgment result as triggers of various controls such as toner supply, toner discharge, toner circulation, and a replacement time.

The entire disclosure of Japanese Patent Application No. 2009-070167, filed Mar. 23, 2009 is expressly incorporated by reference herein.

What is claimed is:

1. A toner deterioration judging method comprising:
measuring a time taken for a recess formed on a toner surface to be evened due to flowability of the toner, and
judging deterioration of the toner in accordance with the measured time.

2. A developing apparatus comprising:
a developing agent carrier that carries toner;
a developing chamber that stores toner supplied to the developing agent carrier;
a first detector that detects a toner level in the developing chamber; and
a second detector that detects a toner level and is arranged so as to be deviated in the vertical direction with respect to the first detector.

3. The developing apparatus according to claim 2, further comprising a moving member that moves toner to be detected by the second detector.

4. The developing apparatus according to claim 3,
wherein the second detector detects toner levels before and after the moving member moves the toner.

5. The developing apparatus according to claim 4,
wherein the moving member is a cleaning member that cleans the first detector.

6. The developing apparatus according to claim 4,
wherein the moving member is a cleaning member that cleans the second detector.

7. The developing apparatus according to claim 2,
wherein the first detector and the second detector are integrally formed.

8. An image forming apparatus comprising at least:
a latent image carrier on which an electrostatic latent image is formed;
a developing apparatus that develops the electrostatic latent image with a developing agent to form a toner image on the latent image carrier; and
a transfer portion that transfers the toner image formed on the latent image carrier onto a transfer material,
wherein the developing apparatus according to claim 2 is provided as the developing apparatus.

9. The image forming apparatus according to claim 8 further comprising a judging portion that judges deterioration of the toner in accordance with a toner level detected by the first detector and a toner absence time detected by the second detector.
